(19) United States
(12) Patent Application Publication
(10) Pub. No.: US 2025/0156764 A1
(43) Pub. Date: May 15, 2025

(54) DATA-EFFICIENT DEMONSTRATION EXPANSION FOR TRAINING A GENERALIST ROBOTIC AGENT

(71) Applicant: NVIDIA Corp., Santa Clara, CA (US)

(72) Inventors: Tongzhou Mu, San Diego, CA (US); Yijie Guo, Seattle, WA (US); Jie Xu, Bellevue, WA (US); Ankit Goyal, Seattle, WA (US); Animesh Garg, Atlanta, GA (US); Dieter Fox, Seattle, WA (US)

(73) Assignee: NVIDIA Corp., Santa Clara, CA (US)

(21) Appl. No.: 18/947,237

(22) Filed: Nov. 14, 2024

Related U.S. Application Data
(60) Provisional application No. 63/599,456, filed on Nov. 15, 2023.

(51) Int. Cl. G06N 20/00

(52) U.S. Cl. CPC G06N 20/00

(57) ABSTRACT

Mechanisms to enhance robotic agent performance utilizing dynamically curated demonstration trajectories to augment agent training, whereby additional demonstrations are dynamically curated or generated and added to the demonstration training set for the robot based on task difficulty and initial state complexity, thereby utilizing a greater number of training demonstrations for unsolved or poorly performing tasks and challenging initial states.

### CROSS-REFERENCE TO RELATED APPLICATIONS

This application claims priority and benefit under 35 U.S.C. 119(e) to application Ser. No. 63/599,456, titled “Adaptive Demonstration Augmentation for Multi-task Visuomotor Policy Learning”, filed on Nov. 15, 2023, the contents of which are incorporated herein by reference in their entirety.

### BACKGROUND

Machine learning approaches may apply data augmentation to training sets by generating additional training inputs using various transformations on existing training sets. Transformations may include rotations, flips, shifts, and cropping. In the context of reinforcement learning and imitation learning for multi-task visuomotor policy training of robots, specialized techniques have been proposed such as enhancing the robustness of visual policies by applying image-based data augmentation techniques to observations. Another approach to generating additional trajectories adapts existing demonstration trajectories to novel situations.

While data augmentation may produce novel data instances, these instances are intrinsically limited in informational value as they are derived from a pre-existing data set. In addition to generating a varied data distribution through data augmentation, some prior mechanisms modify the training data sampling strategy without altering the underlying training data distribution. For instance, some prior mechanisms oversample challenging training cases in the existing training set due to these instances involving more effort for the model under training to accurately fit.

The conventional criteria for increased sampling of specific training cases (demonstrations) typically relies on an assessment of a robot's neural network model's performance with respect to these individual demonstrations. This approach may fail to introduce any new information into the training set and instead merely reallocates the training focus within the training set.

Some conventional approaches employ large-scale pre-training datasets in representation learning, utilizing supervised, self-supervised, or unsupervised methods. This strategy has gained traction in fields like computer vision and natural language processing, where such datasets are abundant. Although these pre-trained representations may enhance a robotic agent's visual comprehension, they do not inherently provide task-specific guidance.

The use of online imitation learning for robotic agents shows promise, but assumes the availability of an expert who can provide immediate action guidance for any state the agent encounters. The practicality of online imitation learning using human experts is constrained by the difficulty of securing an expert capable of offering comprehensive, real-time supervision across possible initial task states.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a multi-task training process for a generalist robotic agent in accordance with one embodiment.

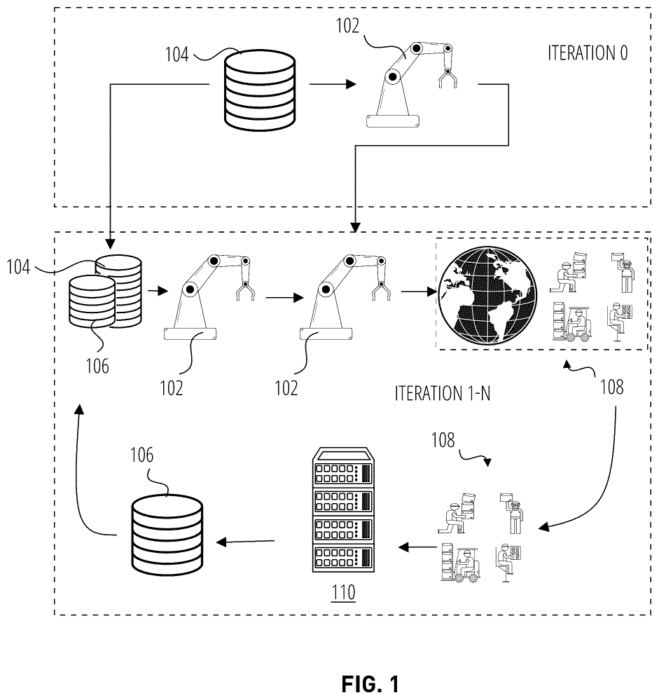

FIG. 2 depicts a training algorithm for a robotic agent in accordance with one embodiment.

FIG. 3 depicts a training algorithm for a robotic agent in accordance with one embodiment.

FIG. 4 depicts a parallel processing unit in accordance with one embodiment.

FIG. 5 depicts a general processing cluster in accordance with one embodiment.

FIG. 6 depicts a memory partition unit in accordance with one embodiment.

FIG. 7 depicts a streaming multiprocessor in accordance with one embodiment.

FIG. 8 depicts a processing system in accordance with one embodiment.

FIG. 9 depicts an exemplary processing system in accordance with another embodiment.

### DETAILED DESCRIPTION

The disclosed mechanisms may be applied to enhance robotic agent performance utilizing, for example, online demonstration trajectories to augment agent training. Rather than uniformly adding demonstrations to all tasks, the disclosed mechanisms may dynamically generate additional demonstrations based on task difficulty and initial state complexity. A greater number of training demonstrations may be generated for unsolved tasks and challenging initial states. In contrast to conventional approaches, the disclosed mechanisms actively generate new demonstrations for initial agent states, significantly reducing the supervision expertise that need be applied.

To improve the efficiency of demonstration expansion, newly-generated demonstrations target trajectory scenarios where the current state of training fails to produce adequate results. The disclosed mechanisms prioritize the collection of demonstrations for tasks with performance outcomes that fail to satisfy a configured goal. Within each task, training is focused on acquiring demonstrations for initial states where the existing tasks underperform. Adapting sampling strategies are utilized during training to place emphasis on challenging tasks. The demonstration expansion process to thereby tailored to address weaknesses of existing demonstration training sets while avoiding the collection of unnecessary demonstrations.

The disclosed mechanisms may provide substantial training efficiencies for robotic agents at points where performance plateaus. These efficiencies may provide substantial cost savings for computing and training resources, especially for large-scale and/or complicated demonstration training sets. Multi-task visual policy learning by robotic agents may thereby be improved by adaptively expanding the demonstration dataset and employing an appropriate sampling strategy for training.

A robot may be trained to implement a single visual policy (a.k.a., a ‘generalist’ policy) comprising multiple tasks, each task comprising different goals and multiple initial states. Practical scenarios for applying generalist policies include a robotic arm performing diverse tasks such as stacking plates and opening drawers, depending on provided instructions and observed objects in the environment.

Training of the robotic agent 102 is initially carried out using an initial demonstration training set 104. Over a number of iterations (rounds), dynamically generated demonstrations 106 are added to the initial demonstration training set 104 and the robotic agent 102 is trained on the resulting enhanced demonstration data set. The performance of the robotic agent 102 on the tasks of the policy are evaluated (task evaluation 108) after training with the enhanced demonstration data set, and additional rounds of demonstration enhancement and training are performed until satisfactory performance is achieved on the policy, or computing resource limits are reached. A demonstration collector 110 may be utilized in the loop to form the set of dynamically generated demonstrations 106.

A robotic task configuration comprises a success metric (the task goal) utilized to verify task completion and to compute the success rate of the task. A generalist policy may be implemented by applying behavior cloning to an algorithmic class that accommodates various state-of-the-art visual policy learning architectures. The demonstration learning set for behavior cloning may be represented as: D0:={ [symbol] ₀¹, . . . , [symbol] ₀^{M}}, where M is the number of tasks that implement in the generalist policy, the superscript m=[1 . . . M] denotes the index of the task, and the subscript 0 denotes an initial pre-collected demonstration training set.

The demonstration training set for each task m may comprise a set of demonstration trajectories τ: [symbol] ₀^{m}:={τ₀^{m}, τ₁^{m}, . . . }. Each demonstration τ may comprise a goal description g and a sequence of state transitions: τ:= [symbol] g, {(o₀, a₀), (o₁, a₁), . . . } [symbol] , where g represents a goal description and oᵢ represents a visual observation that is applied to the visual policy. The parameter aᵢ represents an action that defines outputs that connect states.

Demonstrations for the training set may be sourced through varied methods such as task and motion planning, state-based reinforcement learning, and teleoperation of the robotic agent by humans. Unlike less efficient conventional mechanisms, the demonstration collector may only be applied to the initial states of tasks, not all possible task state. This enables the collection of a suitable demonstration training set using human teleoperation or real-world motion planning, for example.

Generating demonstrations for all possible states is significantly more challenging than focusing on initial states, because human-oriented tasks that are automated by robots may typically be solvable from the initial states. For instance, in a “stacking cup” task, it is practical to generate demonstrations where cups are initially standing on a table. However, if a cup is knocked down or falls from the table during the task execution, creating a demonstration for that state may be difficult or impossible.

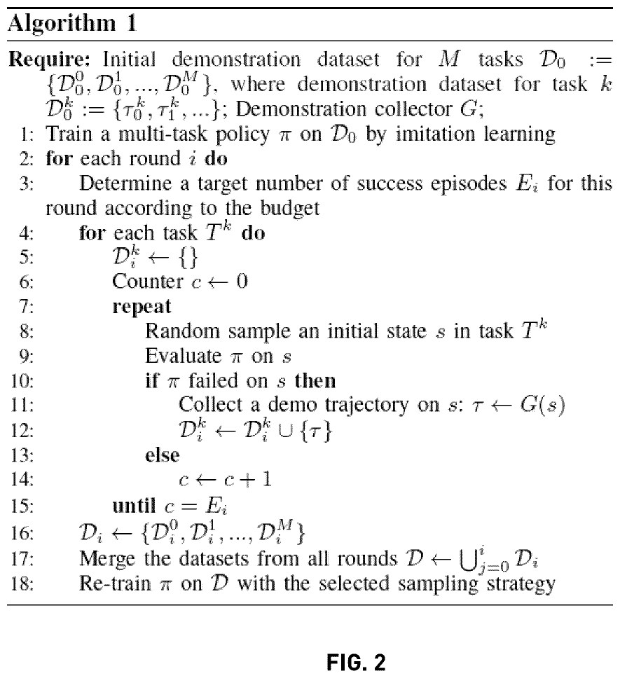

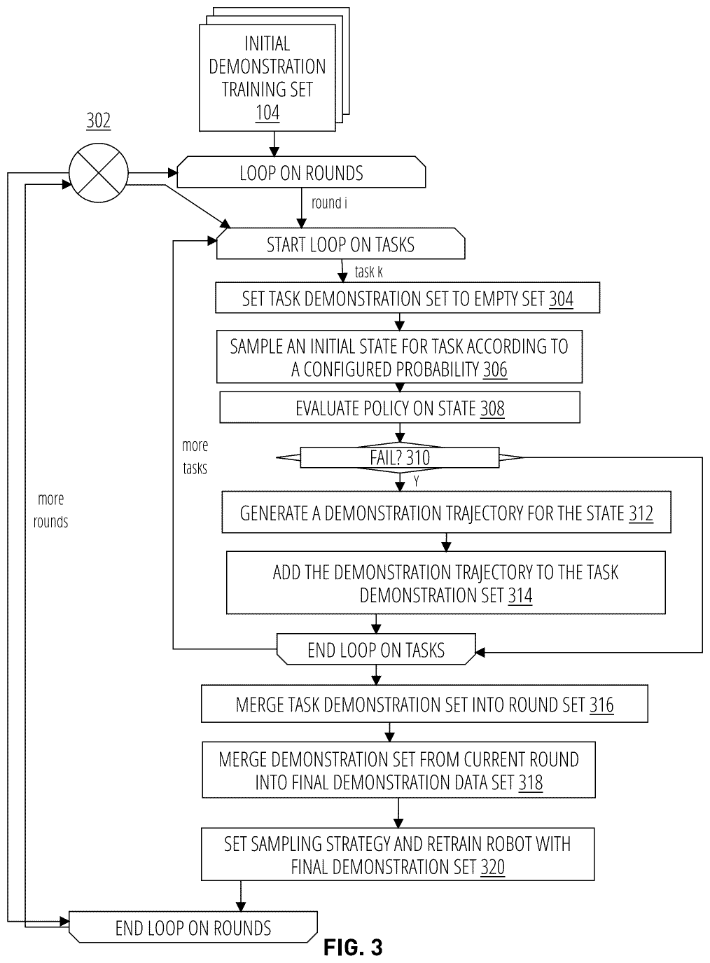

Algorithm 1 in FIG. 2 and the flow chart in FIG. 3 depict an embodiment of logic to implement adaptive demonstration collection and utilization.

The disclosed mechanisms may be utilized to actively and continuously expand the demonstration dataset for training generalist robotic agents, and particularly, for multi-task visual policy learning of said robotic agents. The disclosed mechanisms operate over multiple iterative rounds to progressively improve the demonstration dataset, and consequently, the performance of the policy.

Beginning with the initial (pre-configured) demonstration training set (104), the policy may be reevaluated at each iteration (block 308) to identify and collect new demonstrations that address the policy's weaknesses in its current state, thus reducing collection of unhelpful demonstrations. Fluctuations in control logic 302 are accommodated, enabling the initial use of available resources and the integration of new demonstrations as more resources become available, or the termination of training if the control logic 302 determines that the robot is demonstrating sufficient proficiency on the policy, or the computing resource budget is exhausted.

The demonstration set for a task in a given round is initialized (304) and an initial state for each task from the set is sampled according to a configured probability (306). The acquisition of new demonstrations for initial states where the current policy fails (310) may be targeted (312) and added to the demonstration set for the task in the round (314). This prioritizes collection of demonstrations for tasks where the current policy demonstrates low success rates (success rates that fail to satisfy a configured threshold value).

The process iterates over the tasks to train the robot to perform, merging the demonstration sets for each task into a demonstration set for the current round of training (316). The demonstration set for the current round is merged into a final demonstration training set (318). The robot is then trained on the policy using the final demonstration set (320). This process is repeated for a number of rounds until the robot demonstrates a configured level of proficiency on the policy, or until a preset number of rounds are executed without obtaining the desired level of proficiency.

A different success or failure evaluation function may be configured for each task. The evaluation function may compare a configured goal for the task (e.g., stack two blocks) to an actual outcome obtained from evaluating the outcome of the task based on the current robotic agent training. The goal may in some embodiments be parameterized by one or more matrix in manners known in the art.

For example, a task with a configured goal of stacking a block A on the top of another block B may have a demonstration [(s₀, a₀), (s₁, a₁), . . . , (sₙ, aₙ))], where s indicates a state of the robot and a indicates an action for the robot to take. The demonstration defines one trajectory of states and actions for the robot to take from the initial state s₀ to the goal outcome. For some types of tasks, the states & may be encoded as a combination of an image depicting object positions (e.g., the block position in this example) and the robot proprioception, and the action a may be a command to the robot to cause a particular end effector movement.

An algorithm to evaluate task success or failure evaluation for the example of stacking two blocks may be:

```
IF
  (block A contacts block B) &&
  (block A is on the top of block B) &&
    (robot gripper is empty) THEN
    success
ELSE
    fail
```

A demonstration encodes a motion path (trajectory) for the robot. A demonstration comprises a sequence of physical states (e.g., positions, velocities, gripping pressures, etc.) and actions that the manipulator transitions through to get from an initial state to the goal state. The actions may drive transitions between states. At each state of a demonstration the robot executes an action. The overall demonstration training set for the robot may comprise multiple demonstrations for each task of the policy, each demonstration corresponding to a different initial state.

The initial state sampling strategy that is utilized during training emphasizes tasks that are evaluated to be challenging (e.g., according to a difficulty metric), which helps ensure that the model is continually exposed to and learns from more demanding scenarios. As the multi-task policy on each task is evaluated, specific initial states where the current policy cannot successfully complete the task are identified.

Focusing the sampling strategy on failed initial states leads to the demonstration collector focusing on acquiring new demonstrations that provide more direct guidance for solving scenarios where the policy previously failed, thereby enhancing the data efficiency without misallocating resources on collection of demonstrations for initial states the policy already navigates successfully.

The policy evaluation may be performed on the default initial state distribution for each task. Upon encountering an initial state that leads to an unsuccessful result, a demonstration collector may be engaged to generate an expert demonstration trajectory from that specific initial state. Demonstration collection may be carried out using available commercial and research tools, including task and motion planning systems, state-based reinforcement learning, model predictive control, or human teleoperation in some cases.

Such tools may have the capability to complete a given task from a given initial state. In cases where a demonstration collector fails to complete a task from a particular initial state, the collection process may be reattempted a configured number of times, or or collection of a demonstration for that specific initial state may be skipped.

The system may determine a number of new demonstrations to collect over each round to efficiently allocate the computing resource budget across various tasks. The collection of demonstrations for tasks that remain unsolved may be prioritized. These are the tasks for which the current policy demonstrates success rates that fail to satisfy an evaluation metric or threshold.

The number of new demonstrations to collect in a round for a given task may be determined indirectly. For a given round, a number of successful demonstration outcomes for the task may be configured. For example, assume the current configuration of the robot demonstrates a success rate on a given tasks of around 30%. In order to achieve, for example, 100 successful outcomes on the tasks, approximately 300 demonstrations of the task need to satisfy their configured goals. Over the course of executing the approximately 300 demonstrations, a number of failed outcomes will be recorded for the task.

To indirectly set a total number of demonstration to collect in a round for a given task, a number of successful outcomes of the task to achieve over the course of the round may be configured. For example, assume a task for a robot arm that involves placing one block on the top of another block. This task may begin from many different initial states. For example, the initial state of the robot arm may be in different poses, and/or the initial locations of two blocks may be different. Demonstrations for various initial states are sampled and if the outcomes fail the configured goal, one or more new demonstrations are added to the demonstration training set for that task, thereby implicitly determining a number of new demonstrations to add for the task over the course of the round.

Each task of the policy may be reevaluated until it reaches a predetermined number of successful episodes, or reaches an evaluation failure status. During this reevaluation process, demonstrations are collected from the initial states where the policy fails. Tasks with lower success rates result in more failures during evaluation, leading the system to collect more new demonstrations for those tasks. This results in a direct correlation between a task's difficulty (gauged by its success rate) and the number of demonstrations collected for the task. Resources are concentrated on those tasks where the current policy underperforms, resulting in a more efficient and focused data-collection process.

In one embodiment, an estimate of a number of demonstrations N_{demo}^{k} to apply for a given task k is given by

$${N}_{demo}^{k} = \frac{E}{{SR}^{k}} - E ,$$

where SR^{k} denotes the success rate of the current policy on task k, and E is a hyperparameter specifying the target number of successful completions for the task, which may be adapted based on an available computing resource budget. A cap on the number of demonstrations to be collected per task may be imposed.

Optimization of the expanded demonstration training set may also be performed through a suitable sampling strategy during training. The conventional approach of uniformly sampling across the entire dataset biases towards tasks with longer trajectories, which does not necessarily correlate with their importance to the overall policy performance.

To mitigate bias, the disclosed mechanisms may utilize sampling strategies that more accurately prioritize demonstrations which are crucial for enhancing policy performance. One such approach enforces uniform sampling with respect to tasks, configuring each task with an equal chance of being selected. This mechanism provides a more balanced distribution compared to uniform sampling with respect to the entire dataset, but does not account for more difficult tasks that have a higher impact on the overall policy performance.

Another approach selects samples uniformly with respect to the demonstration trajectories, i.e., the sampling probability for each task is configured to be proportional to the number of demonstration trajectories in the training set for that task. This correlates sampling probability for tasks to the collection of more demonstrations for unsolved tasks, such that more emphasis is placed on unsolved tasks during the training process on the robotic agent. Harder tasks receive more attention, and the utility of additional demonstrations collected during training is enhanced. In one embodiment a minimum sampling weight may be configured for each task to avoid under-sampling of tasks that have a very small number of demonstrations.

The mechanisms disclosed herein may be implemented in and/or by computing devices utilizing one or more graphic processing unit (GPU) and/or general purpose data processor (e.g., a ‘central processing unit’—CPU). For example, a computing device may be configured with machine-readable instructions in a memory that when applied to the GPU and/or CPU implement the disclosed mechanisms. Exemplary configurations of GPUs and/or CPUs will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

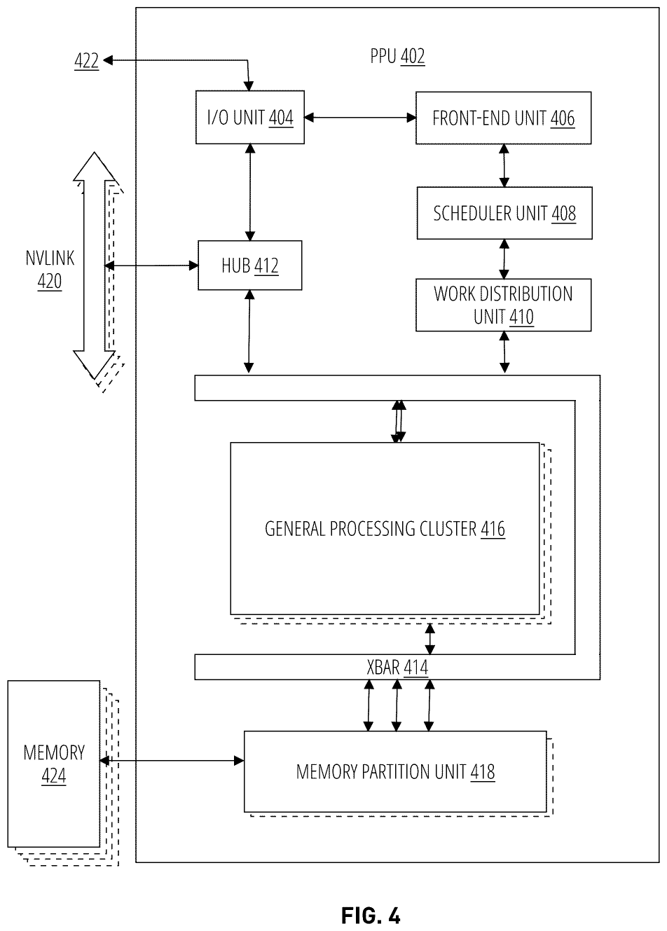

FIG. 4 depicts a parallel processing unit 402, in accordance with an embodiment. In an embodiment, the parallel processing unit 402 is a multi-threaded processor that is implemented on one or more integrated circuit devices. The parallel processing unit 402 is a latency hiding architecture designed to process many threads in parallel. A thread (e.g., a thread of execution) is an instantiation of a set of instructions configured to be executed by the parallel processing unit 402. In an embodiment, the parallel processing unit 402 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 402 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 402 modules may be configured to accelerate thousands of High Performance Computing (HPC), data center, and machine learning applications. The parallel processing unit 402 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the parallel processing unit 402 includes an I/O unit 404, a front-end unit 406, a scheduler unit 408, a work distribution unit 410, a hub 412, a crossbar 414, one or more general processing cluster 416 modules, and one or more memory partition unit 418 modules. The parallel processing unit 402 may be connected to a host processor or other parallel processing unit 402 modules via one or more high-speed NVLink 420 interconnects. The parallel processing unit 402 may be connected to a host processor or other peripheral devices via an interconnect 422. The parallel processing unit 402 may also be connected to a local memory comprising a number of memory 424 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 424 may comprise logic to configure the parallel processing unit 402 to carry out aspects of the techniques disclosed herein.

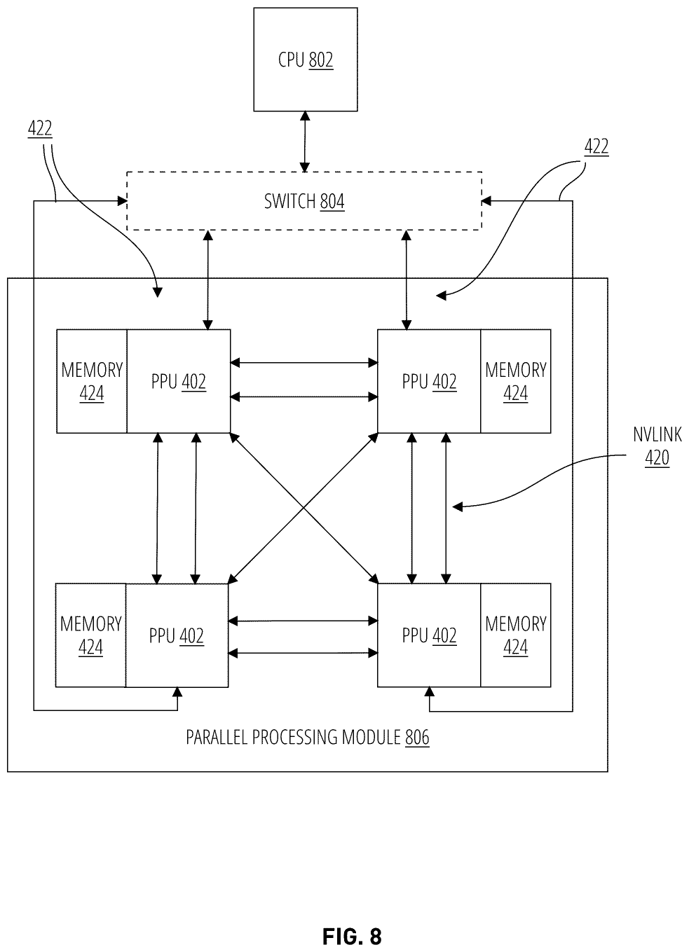

The NVLink 420 interconnect enables systems to scale and include one or more parallel processing unit 402 modules combined with one or more CPUs, supports cache coherence between the parallel processing unit 402 modules and CPUs, and CPU mastering. Data and/or commands may be transmitted by the NVLink 420 through the hub 412 to/from other units of the parallel processing unit 402 such as one or more copy engines, a video encoder, a video decoder, a power management unit, etc. (not explicitly shown). The NVLink 420 is described in more detail in conjunction with FIG. 8.

The I/O unit 404 is configured to transmit and receive communications (e.g., commands, data, etc.) from a host processor (not shown) over the interconnect 422. The I/O unit 404 may communicate with the host processor directly via the interconnect 422 or through one or more intermediate devices such as a memory bridge. In an embodiment, the I/O unit 404 may communicate with one or more other processors, such as one or more parallel processing unit 402 modules via the interconnect 422. In an embodiment, the I/O unit 404 implements a Peripheral Component Interconnect Express (PCIe) interface for communications over a PCIe bus and the interconnect 422 is a PCIe bus. In alternative embodiments, the I/O unit 404 may implement other types of well-known interfaces for communicating with external devices.

The I/O unit 404 decodes packets received via the interconnect 422. In an embodiment, the packets represent commands configured to cause the parallel processing unit 402 to perform various operations. The I/O unit 404 transmits the decoded commands to various other units of the parallel processing unit 402 as the commands may specify. For example, some commands may be transmitted to the front-end unit 406. Other commands may be transmitted to the hub 412 or other units of the parallel processing unit 402 such as one or more copy engines, a video encoder, a video decoder, a power management unit, etc. (not explicitly shown). In other words, the I/O unit 404 is configured to route communications between and among the various logical units of the parallel processing unit 402.

In an embodiment, a program executed by the host processor encodes a command stream in a buffer that provides workloads to the parallel processing unit 402 for processing. A workload may comprise several instructions and data to be processed by those instructions. The buffer is a region in a memory that is accessible (e.g., read/write) by both the host processor and the parallel processing unit 402. For example, the I/O unit 404 may be configured to access the buffer in a system memory connected to the interconnect 422 via memory requests transmitted over the interconnect 422. In an embodiment, the host processor writes the command stream to the buffer and then transmits a pointer to the start of the command stream to the parallel processing unit 402. The front-end unit 406 receives pointers to one or more command streams. The front-end unit 406 manages the one or more streams, reading commands from the streams and forwarding commands to the various units of the parallel processing unit 402.

The front-end unit 406 is coupled to a scheduler unit 408 that configures the various general processing cluster 416 modules to process tasks defined by the one or more streams. The scheduler unit 408 is configured to track state information related to the various tasks managed by the scheduler unit 408. The state may indicate which general processing cluster 416 a task is assigned to, whether the task is active or inactive, a priority level associated with the task, and so forth. The scheduler unit 408 manages the execution of a plurality of tasks on the one or more general processing cluster 416 modules.

The scheduler unit 408 is coupled to a work distribution unit 410 that is configured to dispatch tasks for execution on the general processing cluster 416 modules. The work distribution unit 410 may track a number of scheduled tasks received from the scheduler unit 408. In an embodiment, the work distribution unit 410 manages a pending task pool and an active task pool for each of the general processing cluster 416 modules. The pending task pool may comprise a number of slots (e.g., 32 slots) that contain tasks assigned to be processed by a particular general processing cluster 416. The active task pool may comprise a number of slots (e.g., 4 slots) for tasks that are actively being processed by the general processing cluster 416 modules. As a general processing cluster 416 finishes the execution of a task, that task is evicted from the active task pool for the general processing cluster 416 and one of the other tasks from the pending task pool is selected and scheduled for execution on the general processing cluster 416. If an active task has been idle on the general processing cluster 416, such as while waiting for a data dependency to be resolved, then the active task may be evicted from the general processing cluster 416 and returned to the pending task pool while another task in the pending task pool is selected and scheduled for execution on the general processing cluster 416.

The work distribution unit 410 communicates with the one or more general processing cluster 416 modules via crossbar 414. The crossbar 414 is an interconnect network that couples many of the units of the parallel processing unit 402 to other units of the parallel processing unit 402. For example, the crossbar 414 may be configured to couple the work distribution unit 410 to a particular general processing cluster 416. Although not shown explicitly, one or more other units of the parallel processing unit 402 may also be connected to the crossbar 414 via the hub 412.

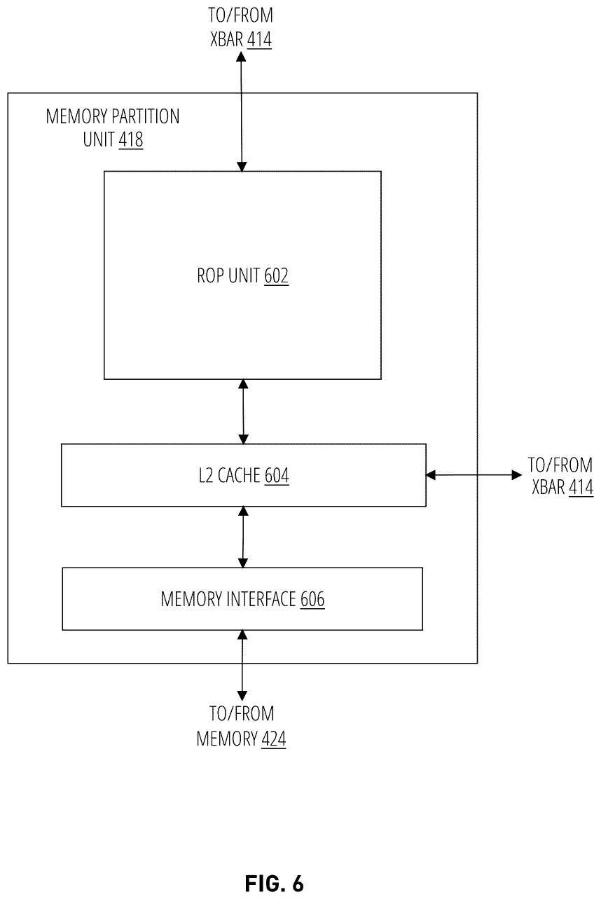

The tasks are managed by the scheduler unit 408 and dispatched to a general processing cluster 416 by the work distribution unit 410. The general processing cluster 416 is configured to process the task and generate results. The results may be consumed by other tasks within the general processing cluster 416, routed to a different general processing cluster 416 via the crossbar 414, or stored in the memory 424. The results can be written to the memory 424 via the memory partition unit 418 modules, which implement a memory interface for reading and writing data to/from the memory 424. The results can be transmitted to another parallel processing unit 402 or CPU via the NVLink 420. In an embodiment, the parallel processing unit 402 includes a number U of memory partition unit 418 modules that is equal to the number of separate and distinct memory 424 devices coupled to the parallel processing unit 402. A memory partition unit 418 will be described in more detail below in conjunction with FIG. 6.

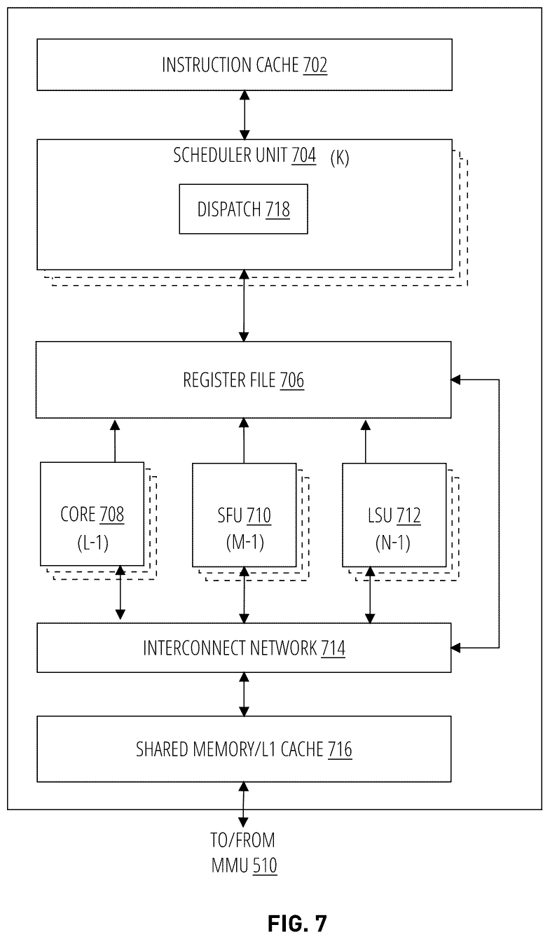

In an embodiment, a host processor executes a driver kernel that implements an application programming interface (API) that enables one or more applications executing on the host processor to schedule operations for execution on the parallel processing unit 402. In an embodiment, multiple compute applications are simultaneously executed by the parallel processing unit 402 and the parallel processing unit 402 provides isolation, quality of service (QoS), and independent address spaces for the multiple compute applications. An application may generate instructions (e.g., API calls) that cause the driver kernel to generate one or more tasks for execution by the parallel processing unit 402. The driver kernel outputs tasks to one or more streams being processed by the parallel processing unit 402. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 7.

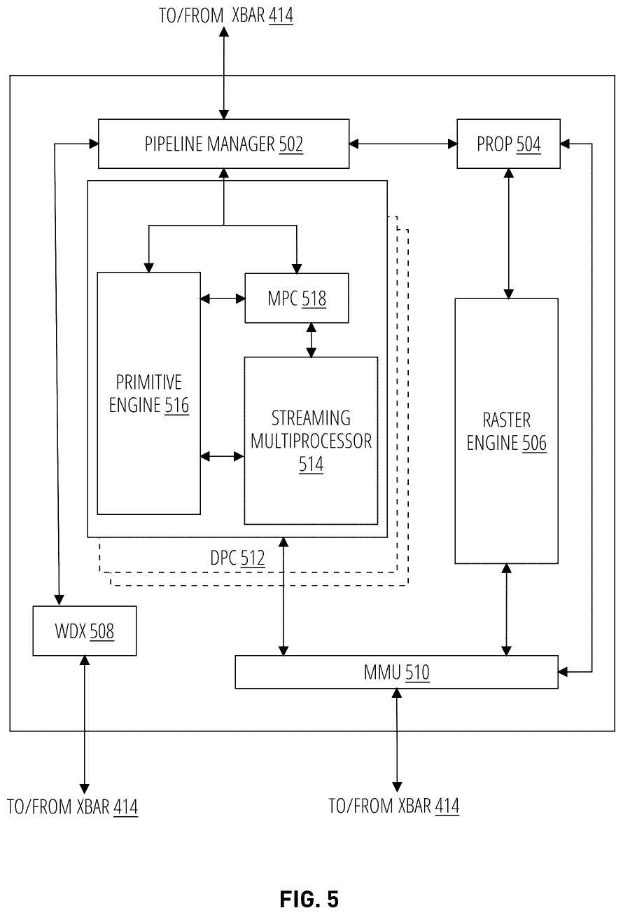

FIG. 5 depicts a general processing cluster 416 of the parallel processing unit 402 of FIG. 4, in accordance with an embodiment. As shown in FIG. 5, each general processing cluster 416 includes a number of hardware units for processing tasks. In an embodiment, each general processing cluster 416 includes a pipeline manager 502, a pre-raster operations unit 504, a raster engine 506, a work distribution crossbar 508, a memory management unit 510, and one or more data processing cluster 512. It will be appreciated that the general processing cluster 416 of FIG. 5 may include other hardware units in lieu of or in addition to the units shown in FIG. 5.

In an embodiment, the operation of the general processing cluster 416 is controlled by the pipeline manager 502. The pipeline manager 502 manages the configuration of the one or more data processing cluster 512 modules for processing tasks allocated to the general processing cluster 416. In an embodiment, the pipeline manager 502 may configure at least one of the one or more data processing cluster 512 modules to implement at least a portion of a graphics rendering pipeline. For example, a data processing cluster 512 may be configured to execute a vertex shader program on the programmable streaming multiprocessor 514. The pipeline manager 502 may also be configured to route packets received from the work distribution unit 410 to the appropriate logical units within the general processing cluster 416. For example, some packets may be routed to fixed function hardware units in the pre-raster operations unit 504 and/or raster engine 506 while other packets may be routed to the data processing cluster 512 modules for processing by the primitive engine 516 or the streaming multiprocessor 514. In an embodiment, the pipeline manager 502 may configure at least one of the one or more data processing cluster 512 modules to implement a neural network model and/or a computing pipeline.

The pre-raster operations unit 504 is configured to route data generated by the raster engine 506 and the data processing cluster 512 modules to a Raster Operations (ROP) unit, described in more detail in conjunction with FIG. 6. The pre-raster operations unit 504 may also be configured to perform optimizations for color blending, organize pixel data, perform address translations, and the like.

The raster engine 506 includes a number of fixed function hardware units configured to perform various raster operations. In an embodiment, the raster engine 506 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 506 comprises fragments to be processed, for example, by a fragment shader implemented within a data processing cluster 512.

Each data processing cluster 512 included in the general processing cluster 416 includes an M-pipe controller 518, a primitive engine 516, and one or more streaming multiprocessor 514 modules. The M-pipe controller 518 controls the operation of the data processing cluster 512, routing packets received from the pipeline manager 502 to the appropriate units in the data processing cluster 512. For example, packets associated with a vertex may be routed to the primitive engine 516, which is configured to fetch vertex attributes associated with the vertex from the memory 424. In contrast, packets associated with a shader program may be transmitted to the streaming multiprocessor 514.

The streaming multiprocessor 514 comprises a programmable streaming processor that is configured to process tasks represented by a number of threads. Each streaming multiprocessor 514 is multi-threaded and configured to execute a plurality of threads (e.g., 32 threads) from a particular group of threads concurrently. In an embodiment, the streaming multiprocessor 514 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 514 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 514 will be described in more detail below in conjunction with FIG. 7.

The memory management unit 510 provides an interface between the general processing cluster 416 and the memory partition unit 418. The memory management unit 510 may provide translation of virtual addresses into physical addresses, memory protection, and arbitration of memory requests. In an embodiment, the memory management unit 510 provides one or more translation lookaside buffers (TLBs) for performing translation of virtual addresses into physical addresses in the memory 424.

FIG. 6 depicts a memory partition unit 418 of the parallel processing unit 402 of FIG. 4, in accordance with an embodiment. As shown in FIG. 6, the memory partition unit 418 includes a raster operations unit 602, a level two cache 604, and a memory interface 606. The memory interface 606 is coupled to the memory 424. Memory interface 606 may implement 32, 64, 128, 1024-bit data buses, or the like, for high-speed data transfer. In an embodiment, the parallel processing unit 402 incorporates U memory interface 606 modules, one memory interface 606 per pair of memory partition unit 418 modules, where each pair of memory partition unit 418 modules is connected to a corresponding memory 424 device. For example, parallel processing unit 402 may be connected to up to Y memory 424 devices, such as high bandwidth memory stacks or graphics double-data-rate, version 5, synchronous dynamic random access memory, or other types of persistent storage.

In an embodiment, the memory interface 606 implements an HBM2 memory interface and Y equals half U. In an embodiment, the HBM2 memory stacks are located on the same physical package as the parallel processing unit 402, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 424 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 402 modules process very large datasets and/or run applications for extended periods.

In an embodiment, the parallel processing unit 402 implements a multi-level memory hierarchy. In an embodiment, the memory partition unit 418 supports a unified memory to provide a single unified virtual address space for CPU and parallel processing unit 402 memory, enabling data sharing between virtual memory systems. In an embodiment the frequency of accesses by a parallel processing unit 402 to memory located on other processors is traced to ensure that memory pages are moved to the physical memory of the parallel processing unit 402 that is accessing the pages more frequently. In an embodiment, the NVLink 420 supports address translation services allowing the parallel processing unit 402 to directly access a CPU's page tables and providing full access to CPU memory by the parallel processing unit 402.

In an embodiment, copy engines transfer data between multiple parallel processing unit 402 modules or between parallel processing unit 402 modules and CPUs. The copy engines can generate page faults for addresses that are not mapped into the page tables. The memory partition unit 418 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 424 or other system memory may be fetched by the memory partition unit 418 and stored in the level two cache 604, which is located on-chip and is shared between the various general processing cluster 416 modules. As shown, each memory partition unit 418 includes a portion of the level two cache 604 associated with a corresponding memory 424 device. Lower level caches may then be implemented in various units within the general processing cluster 416 modules. For example, each of the streaming multiprocessor 514 modules may implement an L1 cache. The L1 cache is private memory that is dedicated to a particular streaming multiprocessor 514. Data from the level two cache 604 may be fetched and stored in each of the L1 caches for processing in the functional units of the streaming multiprocessor 514 modules. The level two cache 604 is coupled to the memory interface 606 and the crossbar 414.

The raster operations unit 602 performs graphics raster operations related to pixel color, such as color compression, pixel blending, and the like. The raster operations unit 602 also implements depth testing in conjunction with the raster engine 506, receiving a depth for a sample location associated with a pixel fragment from the culling engine of the raster engine 506. The depth is tested against a corresponding depth in a depth buffer for a sample location associated with the fragment. If the fragment passes the depth test for the sample location, then the raster operations unit 602 updates the depth buffer and transmits a result of the depth test to the raster engine 506. It will be appreciated that the number of partition memory partition unit 418 modules may be different than the number of general processing cluster 416 modules and, therefore, each raster operations unit 602 may be coupled to each of the general processing cluster 416 modules. The raster operations unit 602 tracks packets received from the different general processing cluster 416 modules and determines which general processing cluster 1 that a result generated by the raster operations unit 602 is routed to through the crossbar 414. Although the raster operations unit 602 is included within the memory partition unit 418 in FIG. 6, in other embodiment, the raster operations unit 602 may be outside of the memory partition unit 418. For example, the raster operations unit 602 may reside in the general processing cluster 416 or another unit.

FIG. 7 illustrates the streaming multiprocessor 514 of FIG. 5, in accordance with an embodiment. As shown in FIG. 7, the streaming multiprocessor 514 includes an instruction cache 702, one or more scheduler unit 704 modules (e.g., such as scheduler unit 408), a register file 706, one or more processing core 708 modules, one or more special function unit 710 modules, one or more load/store unit 712 modules, an interconnect network 714, and a shared memory/L1 cache 716.

As described above, the work distribution unit 410 dispatches tasks for execution on the general processing cluster 416 modules of the parallel processing unit 402. The tasks are allocated to a particular data processing cluster 512 within a general processing cluster 416 and, if the task is associated with a shader program, the task may be allocated to a streaming multiprocessor 514. The scheduler unit 408 receives the tasks from the work distribution unit 410 and manages instruction scheduling for one or more thread blocks assigned to the streaming multiprocessor 514. The scheduler unit 704 schedules thread blocks for execution as warps of parallel threads, where each thread block is allocated at least one warp. In an embodiment, each warp executes 32 threads. The scheduler unit 704 may manage a plurality of different thread blocks, allocating the warps to the different thread blocks and then dispatching instructions from the plurality of different cooperative groups to the various functional units (e.g., core 708 modules, special function unit 710 modules, and load/store unit 712 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 718 unit is configured within the scheduler unit 704 to transmit instructions to one or more of the functional units. In one embodiment, the scheduler unit 704 includes two dispatch 718 units that enable two different instructions from the same warp to be dispatched during each clock cycle. In alternative embodiments, each scheduler unit 704 may include a single dispatch 718 unit or additional dispatch 718 units.

Each streaming multiprocessor 514 includes a register file 706 that provides a set of registers for the functional units of the streaming multiprocessor 514. In an embodiment, the register file 706 is divided between each of the functional units such that each functional unit is allocated a dedicated portion of the register file 706. In another embodiment, the register file 706 is divided between the different warps being executed by the streaming multiprocessor 514. The register file 706 provides temporary storage for operands connected to the data paths of the functional units.

Each streaming multiprocessor 514 comprises L processing core 708 modules. In an embodiment, the streaming multiprocessor 514 includes a large number (e.g., 128, etc.) of distinct processing core 708 modules. Each core 708 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 708 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 708 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++program. At the CUDA level, the warp-level interface assumes 16×16 size matrices spanning all 32 threads of the warp.

Each streaming multiprocessor 514 also comprises M special function unit 710 modules that perform special functions (e.g., attribute evaluation, reciprocal square root, and the like). In an embodiment, the special function unit 710 modules may include a tree traversal unit configured to traverse a hierarchical tree data structure. In an embodiment, the special function unit 710 modules may include texture unit configured to perform texture map filtering operations. In an embodiment, the texture units are configured to load texture maps (e.g., a 2D array of texels) from the memory 424 and sample the texture maps to produce sampled texture values for use in shader programs executed by the streaming multiprocessor 514. In an embodiment, the texture maps are stored in the shared memory/L1 cache 716. The texture units implement texture operations such as filtering operations using mip-maps (e.g., texture maps of varying levels of detail). In an embodiment, each streaming multiprocessor 514 includes two texture units.

Each streaming multiprocessor 514 also comprises N load/store unit 712 modules that implement load and store operations between the shared memory/L1 cache 716 and the register file 706. Each streaming multiprocessor 514 includes an interconnect network 714 that connects each of the functional units to the register file 706 and the load/store unit 712 to the register file 706 and shared memory/L1 cache 716. In an embodiment, the interconnect network 714 is a crossbar that can be configured to connect any of the functional units to any of the registers in the register file 706 and connect the load/store unit 712 modules to the register file 706 and memory locations in shared memory/L1 cache 716.

The shared memory/L1 cache 716 is an array of on-chip memory that allows for data storage and communication between the streaming multiprocessor 514 and the primitive engine 516 and between threads in the streaming multiprocessor 514. In an embodiment, the shared memory/L1 cache 716 comprises 128 KB of storage capacity and is in the path from the streaming multiprocessor 514 to the memory partition unit 418. The shared memory/L1 cache 716 can be used to cache reads and writes. One or more of the shared memory/L1 cache 716, level two cache 604, and memory 424 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 716 enables the shared memory/L1 cache 716 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 4, are bypassed, creating a much simpler programming model. In the general purpose parallel computation configuration, the work distribution unit 410 assigns and distributes blocks of threads directly to the data processing cluster 512 modules. The threads in a block execute the same program, using a unique thread ID in the calculation to ensure each thread generates unique results, using the streaming multiprocessor 514 to execute the program and perform calculations, shared memory/L1 cache 716 to communicate between threads, and the load/store unit 712 to read and write global memory through the shared memory/L1 cache 716 and the memory partition unit 418. When configured for general purpose parallel computation, the streaming multiprocessor 514 can also write commands that the scheduler unit 408 can use to launch new work on the data processing cluster 512 modules.

The parallel processing unit 402 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 402 is embodied on a single semiconductor substrate. In another embodiment, the parallel processing unit 402 is included in a system-on-a-chip (SoC) along with one or more other devices such as additional parallel processing unit 402 modules, the memory 424, a reduced instruction set computer (RISC) CPU, a memory management unit (MMU), a digital-to-analog converter (DAC), and the like.

In an embodiment, the parallel processing unit 402 may be included on a graphics card that includes one or more memory devices. The graphics card may be configured to interface with a PCIe slot on a motherboard of a desktop computer. In yet another embodiment, the parallel processing unit 402 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 8 is a conceptual diagram of a processing system implemented using the parallel processing unit 402 of FIG. 4, in accordance with an embodiment. The processing system includes a central processing unit 802, an switch 804, and multiple parallel processing unit 402 modules each and respective memory 424 modules. The switch 804 is depicted with dashed lines, indicating that it is optional in some embodiments.

The NVLink 420 provides high-speed communication links between each of the parallel processing unit 402 modules. Although a particular number of NVLink 420 and interconnect 422 connections are illustrated in FIG. 8, the number of connections to each parallel processing unit 402 and the central processing unit 802 may vary. The switch 804 interfaces between the interconnect 422 and the central processing unit 802. The parallel processing unit 402 modules, memory 424 modules, and NVLink 420 connections may be situated on a single semiconductor platform to form a parallel processing module 806. In an embodiment, the switch 804 supports two or more protocols to interface between various different connections and/or links.

In another embodiment (not shown), the NVLink 420 provides one or more high-speed communication links between each of the parallel processing unit modules (parallel processing unit 402, parallel processing unit 402, parallel processing unit 402, and parallel processing unit 402) and the central processing unit 802 and the switch 804 (when present) interfaces between the interconnect 422 and each of the parallel processing unit modules. The parallel processing unit modules, memory 424 modules, and interconnect 422 may be situated on a single semiconductor platform to form a parallel processing module 806. In yet another embodiment (not shown), the interconnect 422 provides one or more communication links between each of the parallel processing unit modules and the central processing unit 802 and the switch 804 interfaces between each of the parallel processing unit modules using the NVLink 420 to provide one or more high-speed communication links between the parallel processing unit modules. In another embodiment (not shown), the NVLink 420 provides one or more high-speed communication links between the parallel processing unit modules and the central processing unit 802 through the switch 804. In yet another embodiment (not shown), the interconnect 422 provides one or more communication links between each of the parallel processing unit modules directly. One or more of the NVLink 420 high-speed communication links may be implemented as a physical NVLink interconnect or either an on-chip or on-die interconnect using the same protocol as the NVLink 420.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 806 may be implemented as a circuit board substrate and each of the parallel processing unit modules and/or memory 424 modules may be packaged devices. In an embodiment, the central processing unit 802, switch 804, and the parallel processing module 806 are situated on a single semiconductor platform.

In an embodiment, each parallel processing unit module includes six NVLink 420 interfaces (as shown in FIG. 8, five NVLink 420 interfaces are included for each parallel processing unit module). The NVLink 420 may be operated exclusively for PPU-to-PPU communication as shown in FIG. 8, or some combination of PPU-to-PPU and PPU-to-CPU, when the central processing unit 802 also includes one or more NVLink 420 interfaces.

In an embodiment, the NVLink 420 allows direct load/store/atomic access from the central processing unit 802 to each parallel processing unit module's memory 424. In an embodiment, the NVLink 420 supports coherency operations, allowing data read from the memory 424 modules to be stored in the cache hierarchy of the central processing unit 802, reducing cache access latency for the central processing unit 802. In an embodiment, the NVLink 420 includes support for Address Translation Services (ATS), enabling the parallel processing unit module to directly access page tables within the central processing unit 802. One or more of the NVLink 420 may also be configured to operate in a low-power mode.

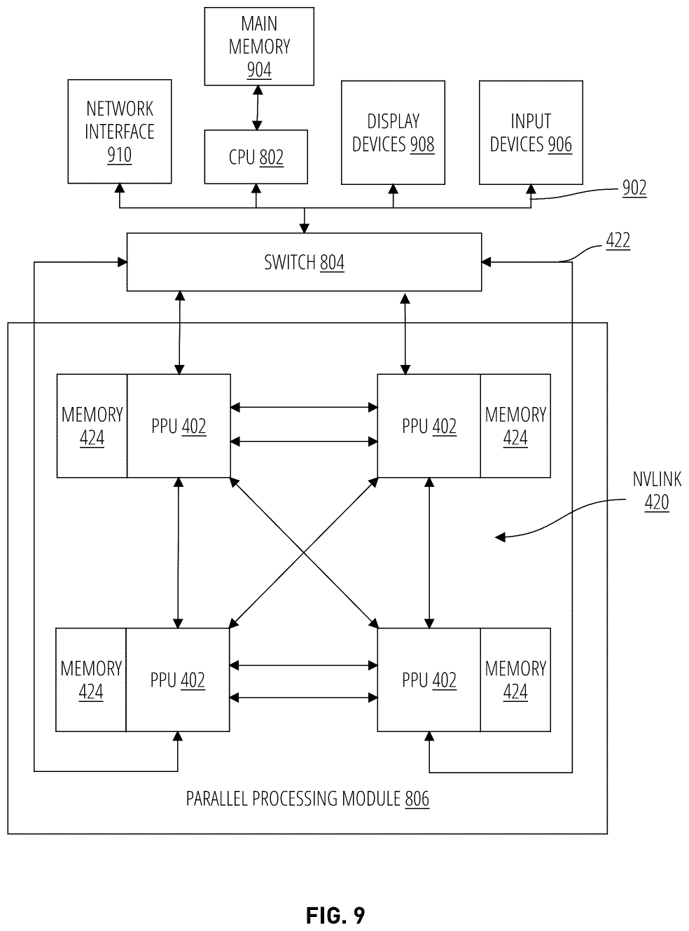

FIG. 9 depicts an exemplary processing system in which the various architecture and/or functionality of the various previous embodiments may be implemented. As shown, an exemplary processing system is provided including at least one central processing unit 802 that is connected to a communications bus 902. The communication communications bus 902 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 904. Control logic (software) and data are stored in the main memory 904 which may take the form of random access memory (RAM).

The exemplary processing system also includes input devices 906, the parallel processing module 806, and display devices 908, e.g. a conventional CRT (cathode ray tube), LCD (liquid crystal display), LED (light emitting diode), plasma display or the like. User input may be received from the input devices 906, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 910 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 904 and/or the secondary storage. Such computer programs, when executed, enable the exemplary processing system to perform various functions. The main memory 904, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

Any one or more of the memory 424, level two cache 604, instruction cache 702, register file 706, shared memory/L1 cache 716, and main memory 904 may be configured with machine-readable instructions to carry out the mechanisms described herein.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 robotic agent
104 initial demonstration training set
106 dynamically generated demonstrations
108 task evaluation
110 demonstration collector
302 control logic
304 action
306 block
308 block
310 decision block
312 block
314 block
316 merge task demonstration set into round set
318 merge demonstration set from current round into final demonstration data set
320 block
402 parallel processing unit
404 I/O unit
406 front-end unit
408 scheduler unit
410 work distribution unit
412 hub
414 crossbar
416 general processing cluster
418 memory partition unit
420 NVLink
422 interconnect
424 memory
502 pipeline manager
504 pre-raster operations unit
506 raster engine
508 work distribution crossbar
510 memory management unit
512 data processing cluster
514 streaming multiprocessor
516 primitive engine
518 M-pipe controller
602 raster operations unit
604 level two cache
606 memory interface
702 instruction cache
704 scheduler unit
706 register file
708 core
710 special function unit
712 load/store unit
714 interconnect network
716 shared memory/L1 cache
718 dispatch
802 central processing unit
804 switch
806 parallel processing module
902 communications bus
904 main memory
906 input devices
908 display devices
910 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A process for configuring a robot to carry out multiple tasks of a configured policy, the process comprising:
iterating over a set of tasks for a robotic manipulator;
sampling an initial state for each task from the set according to a probability;
evaluating an outcome of the task from the initial state under the policy;
on condition that the outcome fails, acquiring a number of new demonstration trajectories for the task and adding the new demonstration trajectories to a demonstration training set for the task;
merging demonstration training sets for the set of tasks into a final demonstration training set; and
applying the final training set to train the robot to implement the policy.

2. The process of claim 1, further comprising:
operating a task and motion planning system for the robot to acquire the number of new demonstration trajectories.

3. The process of claim 1, further comprising:
applying state-based reinforcement learning to acquire the number of new demonstration trajectories.

4. The process of claim 1, further comprising:
operating a model predictive control to acquire the number of new demonstration trajectories.

5. The process of claim 1, further comprising:
determining a number of demonstration trajectories N_{demo}^{k} to apply for each task k according to
$${N}_{demo}^{k} = \frac{E}{{SR}^{k}} - E ,$$
where SR^{k} denotes the success rate of the policy on task k, and E is a parameter specifying a target number of successful completions for the task.

6. The process of claim 5, wherein the number of new demonstration trajectories to acquire for each task k is based on N_{demo}^{k}.

7. The process of claim 5, wherein parameter E is based on an available computing resource budget.

8. The process of claim 1, further comprising:
setting the probability for sampling the initial state of each task proportional to a number of demonstration trajectories in the demonstration training set for the task.

9. A system comprising:
at least one data processor;
a non-volatile machine-readable memory comprising instructions that, when applied to the at least one data processor, configure the system to, for each task represented in a plurality of task configurations for a robot:
(a) compute a probability for sampling an initial state setting for the task;
(b) based on the probability, sample the initial state setting from a plurality of initial state settings for the task;
(c) evaluate an outcome of the task from the initial state setting over a trajectory;
(d) on condition that the outcome fails, acquire new trajectories for the task that begin at the initial state setting, and add the new trajectories to a training set for the task;
(e) merge the training set for the task into a total training set for the robot; and
repeat (a) through (e) until the robot's performance on a policy comprising the plurality of task configurations satisfies a condition, or a computing resource budget is met.

10. The system of claim 9, wherein the instructions, when applied to the at least one data processor, further configure the system to:
operate a task and motion planning system for the robot to acquire the new trajectories for the task.

11. The system of claim 9, wherein the instructions, when applied to the at least one data processor, further configure the system to:
apply state-based reinforcement learning to acquire the new demonstration trajectories for the task.

12. The system of claim 9, wherein the instructions, when applied to the at least one data processor, further configure the system to:
operate a model predictive control to acquire the new trajectories for the task.

13. The system of claim 9, wherein the instructions, when applied to the at least one data processor, further configure the system to:
determine a number of trajectories N_{demo}^{k} to sample for the task according to
$${N}_{demo}^{k} = \frac{E}{{SR}^{k}} - E ,$$
where SR^{k} denotes the success rate of the task, and E is a parameter specifying a target number of successful completions of the task.

14. The system of claim 13, wherein the number of new trajectories to acquire for the task is based on N_{demo}^{k}.

15. The system of claim 13, wherein parameter E is based on an available computing resource budget.

16. The system of claim 9, wherein the instructions, when applied to the at least one data processor, further configure the system to:
set the probability for sampling the initial state of the task proportional to a number of existing trajectories in the training set for the task.

17. A non-volatile machine-readable memory comprising instructions that, when applied to at least one data processor, configure the at least one data processor to, for each task represented in a plurality of task configurations for a robot:
(a) compute a probability for sampling an initial state setting for the task;
(b) based on the probability, sample the initial state setting from a plurality of initial state settings for the task;
(c) evaluate an outcome of the task from the initial state setting over a trajectory;
(d) on condition that the outcome fails, acquire new trajectories for the task that begin at the initial state setting, and add the new trajectories to a training set for the task;
(e) merge the training set for the task into a total training set for the robot; and
repeat (a) through (e) until the robot's performance on a policy comprising the plurality of task configurations satisfies a condition, or a computing resource budget is met.

18. The non-volatile machine-readable memory of claim 17, wherein the instructions, when applied to the at least one data processor, further configure the the at least one data processor to:
determine a number of trajectories N_{demo}^{k} to sample for the task according to
$${N}_{demo}^{k} = \frac{E}{{SR}^{k}} - E ,$$
where SR^{k} denotes the success rate of the task, and E is a parameter specifying a target number of successful completions of the task.

19. The non-volatile machine-readable memory of claim 18, wherein the number of new trajectories to acquire for the task is based on N_{demo}^{k}.

20. The non-volatile machine-readable memory of claim 17, wherein the instructions, when applied to the at least one data processor, further configure the at least one data processor to:
set the probability for sampling the initial state of the task proportional to a number of existing trajectories in the training set for the task.
